(19) United States
(12) Patent Application Publication
(10) Pub. No.: US 2020/0321722 A1
(43) Pub. Date: Oct. 8, 2020

(54) CONNECTOR HOUSING

(71) Applicants: YAZAKI CORPORATION, Tokyo (JP); HONDA MOTOR CO., LTD., Tokyo (JP)

(72) Inventors: Kazuyuki Ochiai, Wako-shi (JP); Daisuke Fujihira, Wako-shi (JP); Tomoyuki Miyakawa, Utsunomiya-shi (JP); Kozo Oishi, Utsunomiya-shi (JP); Erika Kodaira, Utsunomiya-shi (JP)

(21) Appl. No.: 16/907,136

(22) Filed: Jun. 19, 2020

Related U.S. Application Data
(63) Continuation of application No. PCT/JP2018/040228, filed on Oct. 30, 2018.

(30) Foreign Application Priority Data
Dec. 21, 2017 (JP) 2017-245407

(51) Int. Cl. H01R 13/436; H01R 13/422

(52) U.S. Cl. CPC H01R 13/4368; H01R 13/4223

(57) ABSTRACT

This connector housing includes a housing body, terminal accommodating chambers provided, in the housing body, in a plurality of stages in the vertical direction; and lances for locking a terminal when the terminal is inserted from the rear into a terminal accommodating chamber. The lances are provided on the lower side in the upper terminal accommodating chamber and on the upper side in the lower terminal accommodating chamber, and are provided at a distance from each other in the lateral direction when viewed from above.

### CROSS REFERENCE TO RELATED APPLICATIONS

This application is a continuation of PCT application No. PCT/JP2018/040228, which was filed on Oct. 30, 2018 based on Japanese Patent Application (No, 2017-245407) filed on Dec. 21, 2017, the contents of which are incorporated herein by reference.

### BACKGROUND OF THE INVENTION

### 1. Field of the Invention

The present invention relates to a connector housing in which a lance that retains a terminal inserted in each terminal accommodating chamber is provided.

### 2. Description of the Related Art

A connector used for connection of an electric system of an automobile generally includes a connector housing made of resin and a terminal that is inserted into a terminal accommodating chamber provided in the connector housing. The terminal is generally locked by a flexible lance provided in the terminal accommodating chamber.

In general, when the terminal is inserted into the terminal accommodating chamber, the lance is pressed by the terminal and bends in deformation in a direction orthogonal to an insertion direction of the terminal, and the lance is restored to a shape before deformation by entering a locking hole of the terminal when the terminal reaches a predetermined position, so as to lock the terminal.

For example, in one related-art connector as described in JP-A-H7-153523, in a case where a connector housing thereof has a plurality of terminal accommodating chambers and a plurality of lances, the plurality of lances are arranged such that interference among the lances is prevented. Specifically, as illustrated in FIG. 5, with respect to a first connector 110 including a female terminal 118, in a terminal accommodating chamber 112A on an upper side of a connector housing 111, a lance 113 is provided on an upper wall portion (upper side) that defines the terminal accommodating chamber 112A. Meanwhile, in a terminal accommodating chamber 112B on a lower side, the lance 113 is provided on a lower wall portion (lower side) that defines a terminal accommodating chamber 1120. Similarly, with respect to a second connector 120 including a male terminal 128, in a terminal accommodating chamber 122A on an upper side of a connector housing 121, a lance 123 is provided on an upper wall portion (upper side) that defines the terminal accommodating chamber 122A. Meanwhile, in a terminal accommodating chamber 122B on a lower side, the lance 123 is provided on a lower wall portion (lower side) that defines the terminal accommodating chamber 122B.

In the related connector housing described above, the plurality of lances are arranged in a distributed manner at various positions of the connector housing so as to prevent interference among the lances. However, in actually manufacturing the connector housing, the design is performed in consideration of a movable range, a strength, and the like of each of the lances arranged in a distributed manner, the degree of freedom in designing the connector housing is slightly lowered, and a size of the connector housing tends to increase.

### SUMMARY OF THE INVENTION

An object of the present invention is to provide a connector housing capable of achieving both prevention of interference among lances and downsizing.

(1) In a first aspect of the present invention, a connector housing includes:

a housing main body configured to be fitted with a housing of a corresponding connector;

a plurality of terminal accommodating chambers that are arranged in a plurality of stages in an upper-lower direction at an inner portion of the housing main body for accommodating terminals from a rear side of the terminal accommodating chambers, in which among directions orthogonal to an insertion direction of the terminals at the time of assembling the terminal to the housing main body, one direction is taken as the upper-lower direction, and another direction, among other directions, which is orthogonal to the upper-lower direction is taken as a left-right direction; and

a plurality of lances provided in the plurality of terminal accommodating chambers, configured to be pressed by the terminals to bend in deformation when the terminals are inserted into the terminal accommodating chambers from the rear side, and configured to be restored from bending state to lock the terminals when the terminals are inserted to predetermined positions, in which a lance among the plurality of lances is provided on a lower side in an upper terminal accommodating chamber of at least two of the terminal accommodating chambers, and a lance among the plurality of lances is provided on an upper side in a lower terminal accommodating chamber of the at least two of the terminal accommodating chambers, the at least two of the terminal accommodating chambers being adjacent in the upper-lower direction, and the plurality of lances are spaced apart from each other in the left-right direction as viewed from above.

(2) In a second aspect of the present invention, in the connector housing according to the first aspect, the plurality of lances are configured such that at least parts of bending deformation ranges of the lances at the time the terminals are inserted into the terminal accommodating chambers overlap with each other as viewed from the left-right direction.

(3) In a third aspect of the present invention, in the connector housing according to the first aspect or the second aspect, an insertion hole for a terminal extraction tool that releases locking of the lances with respect to the terminals by bending the lances is provided as a common insertion hole between the plurality of terminal accommodating chambers.

In the first aspect, the lance is provided on a lower side in the upper terminal accommodating chamber and the lance is provided on an upper side in the lower terminal accommodating chamber. Therefore, as compared with a case where a plurality of lances are arranged in a distributed manner as in a related-art connector housing, the lances are arranged close to each other. Further, the lances are spaced apart in the left-right direction. Therefore, even if a plurality of lances are arranged close to each other, interference among the lances is prevented. Therefore, the connector housing according to the first aspect can achieve both the prevention of interference among the lances and the reduction in size.

In the second aspect, at least parts of the bending deformation ranges of the upper and lower lances are set to overlap each other as viewed from the left-right direction. Therefore, the distance between the terminal accommodating chambers can be reduced while avoiding interference among the lances. As a result, it is possible to further reduce the size of the connector housing.

In the third aspect, it is possible to further reduce the size of the connector housing by making the insertion hole for inserting the terminal extraction tool common.

According to the present invention, it is possible to achieve both prevention of interference between the lances and reduction in size.

The present invention has been briefly described above. Further, details of the present invention will be clarified by reading a mode for carrying out the invention (hereinafter, referred to as “embodiment”) described below with reference to the accompanying drawings.

### BRIEF DESCRIPTION OF DRAWINGS

FIG. 1 is an exploded perspective view of a connector that uses a connector housing according to an embodiment of the present invention.

FIG. 2 is a perspective view of two connector housings according to the embodiment of the present invention.

FIG. 3 is a front view of a first connector housing among the two connector housings according to the embodiment of the present invention.

FIG. 4 is a cross-sectional view taken along a line A-A of FIG. 3 and an enlarged view of a main part thereof.

FIG. 5 is a cross-sectional view of a related-art connector.

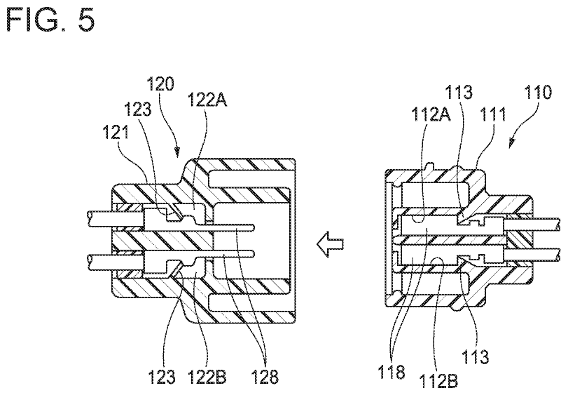

### DETAILED DESCRIPTION OF THE EXEMPLARY EMBODIMENTS

A specific embodiment according to the present invention will be described below with reference to the drawings.

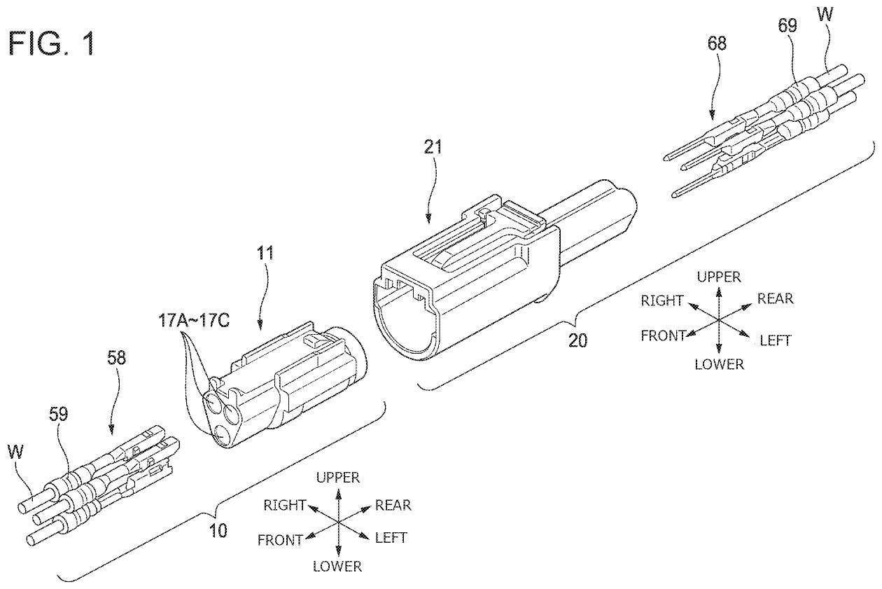

FIG. 1 is an exploded perspective view of a connector that uses a connector housing according to an embodiment of the present invention. The connector is a connector of a simple waterproof type, and as illustrated in FIG. 1, is configured by a combination of a first connector 10 and a second connector 20 that are to be fitted with each other.

The first connector 10 mainly includes a first connector housing 11 of a male type and made of a resin. A plurality of female metal terminals 58 respectively attached to tip ends of electric wires W are mounted in the first connector housing 11. Rubber waterproof plugs 59 are attached to rear ends of the female terminals 58. The waterproof plugs 59 seal rear ends of terminal accommodating chambers 17A to 17C when the terminals 58 are inserted into the respective terminal accommodating chambers 17A to 17C of the first connector housing 11.

The second connector 20 mainly includes a second connector housing 21 of a female type and made of a resin. A plurality of male metal terminals 68 respectively attached to tip ends of the electric wires W are mounted in an inner portion of the first connector housing 21. Rubber waterproof plugs 69 are attached to rear ends of the male terminals 68. The waterproof plugs 69 seal rear ends of terminal accommodating chambers when the terminals 68 are inserted into the respective terminal accommodating chambers (not illustrated) of the first connector housing 21.

In this connector, when the first connector 10 and the second connector 20 are fitted to each other, intrusion of water into an electrical contact portion between the terminals 58 and 68 is prevented by function of a waterproof material (not illustrated) mounted in the inner portion of one of the connector housing 21. The intrusion of water into the terminal accommodating chambers is prevented by the waterproof plugs 59 and 69.

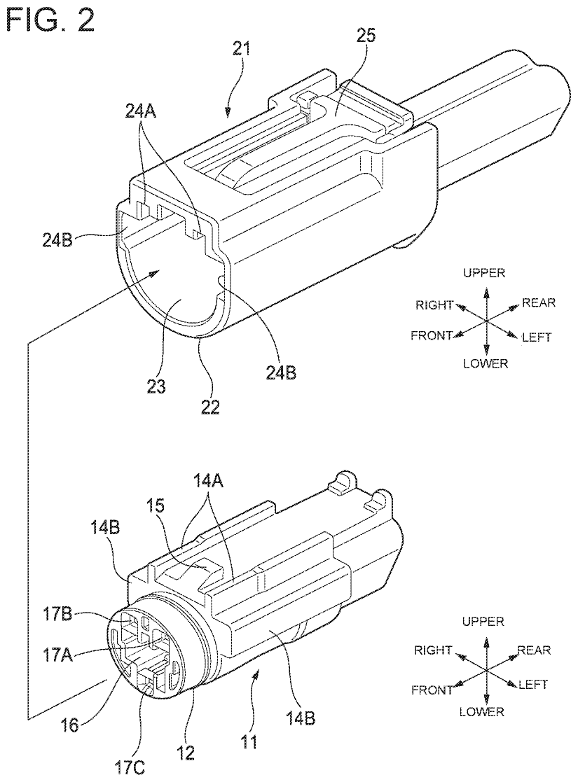

FIG. 2 is a perspective view of two connector housings. As illustrated in FIG. 2, the first connector housing 11 includes a housing main body 12, The second connector housing 21 includes a housing main body 22 having a fitting hole 23, into which the housing main body 12 of the first connector housing 11 is fitted. The fitting hole 23 is directed to a front side of the second connector housing 21.

Here, for convenience of description, with respect to the first connector housing 11, an insertion direction (corresponding to a fitting direction of the first connector 10 and the second connector 20) of the terminal 58 at the time of assembling the terminal 58 to the housing main body 12 is defined as a front side, and an opposite direction thereof is defined as a rear side. Among directions orthogonal to the insertion direction of the terminal 58, one direction is defined as an upper-lower direction, and a direction orthogonal to the upper-lower direction among the other directions is defined as a left-right direction.

With respect to the second connector housing 21, an insertion direction (corresponding to the fitting direction of the first connector 10 and the second connector 20) of the terminal 68 at the time of assembling the terminal 68 to the housing main body 22 is defined as a front side, and an opposite direction thereof is defined as a rear side. Among directions orthogonal to the insertion direction of the terminal 68, one direction is defined as an upper-lower direction, and a direction orthogonal to the upper-lower direction among the other directions is defined as a left-right direction.

Guide protrusions 14A and 14B are provided on an upper surface and right and left side surfaces of the housing main body 12 of the first connector housing 11, Guide recessed portions 24A and 24B are provided on an inner peripheral surface of the fitting hole 23 of the housing main body 22 of the second connector housing 21. When the first connector housing 11 and the second connector housing 21 are fitted, the guide protrusions 14A and 14B are fitted into the guide recessed portions 24A and 24B to guide the fitting between the first connector housing 11 and the second connector housing 21.

A lock portion 15 is provided on the upper surface of the housing main body 12 of the first connector housing 11, and a lock arm 25 is provided on an upper portion of the housing main body 22 of the second connector housing 21. When the first connector housing 11 and the second connector housing 21 are fitted to each other, the first connector housing 11 and the second connector housing 21 are locked by engagement between the lock arm 25 and the lock portion 15.

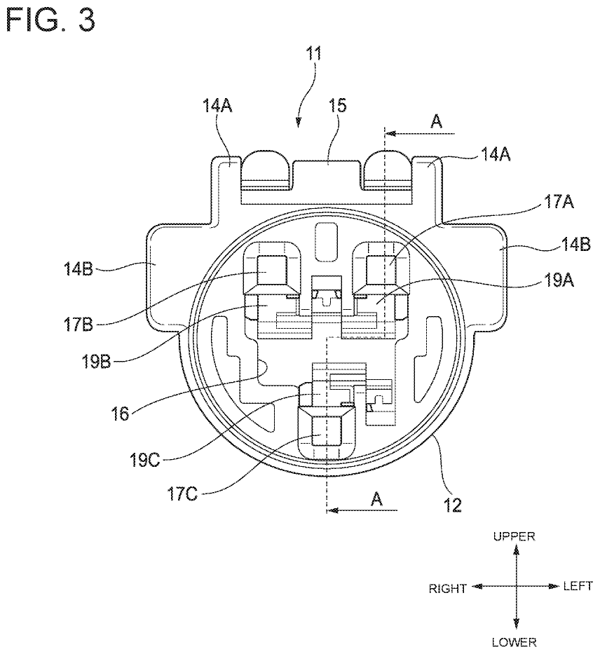

FIG. 3 is a front view of the first connector housing among the two connector housings. As illustrated in FIG. 3, three terminal accommodating chambers 17A, 17B, and 17C extending in a front-rear direction are provided at an inner portion of the housing main body 12 of the first connector housing 11. The three terminal accommodating chambers 17A, 17B, and 17C extend in parallel to each other along the front-rear direction and are arranged at positions of three vertexes of a triangle. That is, at positions of an upper stage, two terminal accommodating chambers 17A and 17B are arranged side by side to the left and right. At a position of a lower stage, one terminal accommodating chamber 17C is arranged. The terminal accommodating chamber 17C of the lower stage is arranged between the two terminal accommodating chambers 17A and 173 of the upper stage as viewed from above. The female terminal 58 is inserted into each of the terminal accommodating chambers 17A, 17B, and 17C from the rear side.

The terminal accommodating chambers 17A, 17B, and 17C are provided with lances 19A, 19B, and 19C, respectively. Each of the lances 19A, 19B, and 19C is a flexible piece that retains and locks the terminal 58 when the terminal 58 is inserted into each of the terminal accommodating chambers 17A, 173, and 17C from the rear side. That is, the lances 19A, 19B, and 19C are pressed by the terminal 58 inserted from the rear side into the terminal accommodating chambers 17A, 17B, and 17C, are bent in deformation in the upper-lower direction, and at a stage where the terminals 58 are inserted to a predetermined position, and then are restored from the bending to lock the terminal 58.

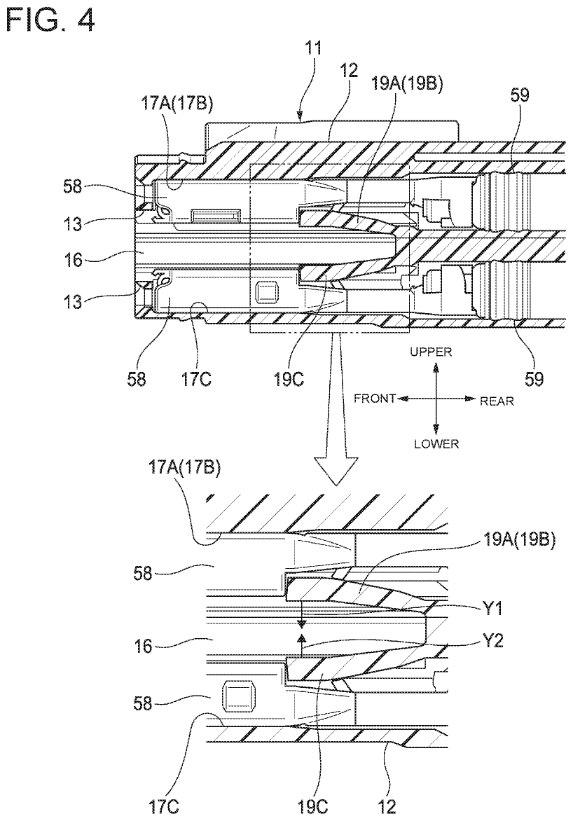

FIG. 4 is a cross-sectional view taken along a line A-A of FIG. 3 and an enlarged view of a main part thereof. As illustrated in FIGS. 3 and 4, the lances 19A, 19B, and 19C are provided in the respective terminal accommodating chambers 17A, 17B, and 17C, and are formed integrally with the housing main body 12. The lances 19A and 193 of the terminal accommodating chambers 17A and 17B on an upper side are arranged on a lower side of the terminal accommodating chambers 174 and 17B. The lance 19C of the terminal accommodating chamber 17C on a lower side is arranged on an upper side of the terminal accommodating chamber 17C. That is, the lances 19A, 19B, and 19C are arranged at positions facing the terminal accommodating chambers 17A, 17B, and 17C in the upper-lower direction respectively, which are adjacent in the upper-lower direction. The lances 19A and 19B of the terminal accommodating chambers 17A and 17B on the upper side and the lance 19C of the terminal accommodating chamber 17C on the lower side are provided at positions spaced apart from each other in the left-right direction as viewed from above.

As illustrated in FIG. 4, when the terminal 58 is inserted from the rear side toward the front side, the lance 19A of the terminal accommodating chamber 17A on the upper side is pressed by the terminal 58 and bends in deformation toward a lower side (in a direction of an arrow Y1), When the terminal 58 is inserted from the rear side toward the front side, the lance 19C of the lower terminal accommodating chamber 17C on the lower side is pressed by the terminal 58 and bends in deformation toward an upper side (in a direction of an arrow Y2). These bending deformation ranges do not overlap because the position of the lance 19A of the upper stage and the position of the lance 19C of the lower stage are deviated in the left-right direction. Therefore, it is possible to form the lances such that at least parts of the bending deformation ranges of the lance 19A of the upper stage and the lance 19C of the lower stage overlap as viewed in the left-right direction. The same applies to the lance 19B of the upper stage and the lance 19C of the lower stage as well.

Further, between the terminal accommodating chambers 17A and 17B of the upper stage and the terminal accommodating chamber 17C of the lower stage, an insertion hole 16 of a terminal extraction tool (not illustrated) is provided as common insertion holes directing from the front side to the rear side. When the terminal extraction tool is inserted into the insertion hole 16 of the connector housing 11 from the front side, locking of the lances 19A to 19C with respect to the terminal 58 is released by bending the lances 19A to 19C. Therefore, in this state, the terminal 58 can be pulled out from the connector housing 11 by pulling the electric wire W toward the rear side.

According to the first connector housing 11 in which the lances 19A to 19C are formed as described above, the lance 19C of the lower stage can be arranged without considering the influence of the bending of the lances 19A and 19B of the upper stage. In addition, the lances 19A and 19B of the upper stage can be arranged without considering the influence of the bending of the lance 19C of the lower stage. Therefore, distances among the upper and lower terminal accommodating chambers 17A, 17B, and 17C can be reduced while avoiding interference among the lances 19A to 19C, and the connector housing 11 can be reduced in size.

In particular, the distances among the upper and lower terminal accommodating chambers 17A to 17C can be further reduced, by setting the bending deformation ranges of the upper and lower lances 19A to 19C such that at least parts thereof overlap as viewed from the left-right direction. As a result, it is possible to further reduce the size of the connector housing 11.

The second connector housing 21 is also provided with terminal accommodating chambers (not illustrated) corresponding to the first connector housing 11. Further, a lance (not illustrated) that retains and locks the terminal 68 inserted from the rear side is provided for each terminal accommodating chamber. These lances can also be formed in the same manner as in the first connector housing 11.

The present invention is not limited to the above embodiment, and includes other configurations and the like which can achieve the object of the present invention, and the following modifications and the like are also contained in the present invention.

For example, in the embodiment described above, a case is described in which the three terminal accommodating chambers 17A to 17C are arranged in two stages, an upper stage and a lower stage, and the number of stages of the terminal accommodating chamber in the upper-lower direction and an arrangement number of the terminal accommodating chamber in the left-right direction are not particularly limited.

Further, the lances are not required to be arranged as described above in all the terminal accommodating chambers, and the lances may be arranged as described above in at least some of the terminal accommodating chambers. For example, in a case of a hybrid connector that accommodates a low voltage terminal and a high voltage terminal, a lance may not be provided in a high voltage terminal accommodating chamber. In this case, a lance may be arranged as described above only in a low voltage terminal accommodating chamber.

Further, characteristics of the embodiment of the connector housing according to the present invention described above will be briefly summarized in the following [1] to [3].

[1] A connector housing (11), including:

a housing main body (12) configured to be fitted with a housing (21) of a mating connector;

a plurality of terminal accommodating chambers (17A, 17B, 17C) that are arranged in a plurality of stages in an upper-lower direction at an inner portion of the housing main body (12) for accommodating terminals (58) from a rear side of the terminal accommodating chambers, in which among directions orthogonal to an insertion direction of the terminal (58) at the time of assembling the terminals (58) to the housing main body (12), one direction is taken as the upper-lower direction, and another direction, among other directions, which is orthogonal to the upper-lower direction is taken as a left-right direction; and

a plurality of lances (19A, 19B, 19C) provided in the plurality of terminal accommodating chambers (17A, 17B, 17C), configured to be pressed by the terminal (58) when the terminals (58) are inserted into the terminal accommodating chambers (17A, 17B, 17C) from the rear side, and configured to be restored from bending state to lock the terminals when the terminals (58) are inserted to predetermined positions,

in which a lance among the plurality of lances is provided on a lower side in an upper terminal accommodating chamber (17A, 17B) of at least two of the terminal accommodating chambers, and a lance among the plurality of lances is provided on an upper side in a lower terminal accommodating chamber (17C) of the at least two of the terminal accommodating chambers, the at least two of the terminal accommodating chambers (17A, 17B, 17C) being adjacent in the upper-lower direction, and the plurality of lances are spaced apart from each other in the left-right direction as viewed from above.

[2] The connector housing (11) according to the above [1], in which the plurality of lances (19A, 19B, and 19C) are configured such that at least parts of bending deformation ranges of the lances at the time the terminals are inserted into the terminal accommodating chambers overlap with each other as viewed from the left-right direction.

[3] The connector housing (11) according to the above [1] or [2], in which

an insertion hole (16) for a terminal extraction tool that releases locking of the lance (19A, 19B, 19C) with respect to the terminals (58) by bending the lances (19A, 19B, 19C) is provided as a common insertion hole between the plurality of terminal accommodating chambers (17A, 17B, and 17C).

The connector housing of the present invention can achieve both prevention of interference among the lances and the reduction in size. The present invention having this effect can be used, for example, in a connector housing for connection of an electric system of an automobile.

What is claimed is:

1. A connector housing, comprising:
a housing main body configured to be fitted with a housing of a mating connector;
a plurality of terminal accommodating chambers that are arranged in a plurality of stages in an upper-lower direction at an inner portion of the housing main body for accommodating terminals from a rear side of the terminal accommodating chambers, wherein among directions orthogonal to an insertion direction of the terminals at the time of assembling the terminal to the housing main body, one direction is taken as the upper-lower direction, and another direction, among other directions, which is orthogonal to the upper-lower direction is taken as a left-right direction; and
a plurality of lances provided in the plurality of terminal accommodating chambers, configured to be pressed by the terminals to bend in deformation when the terminals are inserted into the terminal accommodating chambers from the rear side, and configured to be restored from bending state to lock the terminals when the terminals are inserted to predetermined positions,
wherein a lance among the plurality of lances is provided on a lower side in an upper terminal accommodating chamber of at least two of the terminal accommodating chambers and a lance among the plurality of lances is provided on an upper side in a lower terminal accommodating chamber of the at least two of the terminal accommodating chambers, the at least two of the terminal accommodating chambers being adjacent in the upper-lower direction; and
wherein the plurality of lances are spaced apart from each other in the left-right direction as viewed from above; and
wherein an insertion hole for a terminal extraction tool that releases locking of the lances with respect to the terminals by bending the lances is provided as a common insertion hole between the plurality of terminal accommodating chambers.

2. The connector housing according to claim 1, wherein the plurality of lances are configured such that at least parts of bending deformation ranges of the lances at the time the terminals are inserted into the terminal accommodating chambers overlap with each other as viewed from the left-right direction.

3. The connector housing according to claim 1, wherein each of the plurality of terminal accommodating chambers includes an end wall configured to abut against a front end face of the terminal inserted into the corresponding terminal accommodating chamber, the end wall having a through hole through which a mating terminal assembled to the housing of the mating connector; and
wherein the insertion hole has a space arranged between the end wall of the upper terminal accommodating chamber and the end wall of the lower terminal accommodating chamber as an opening part opened toward the front side for inserting the terminal extraction tool.
